(19) United States
(12) Patent Application Publication
(10) Pub. No.: US 2003/0164222 A1
(43) Pub. Date: Sep. 4, 2003

(54) Semi-solid primer compositions

(76) Inventors: Brendan J. Kneafsey, Dublin (IE); John Guthrie, Kildare (IE)

Correspondence Address: Henkel Loctite Corporation, 1001 Trout Brook Crossing, Rocky Hill, CT, 06067, US

(21) Appl. No.: 10/276,421

(22) PCT Filed: May 30, 2001
(86) PCT No.: PCT/IE01/00070

(30) Foreign Application Priority Data
May 31, 2000 (IE) 2000/0439

(51) Int. Cl. C09J 5/04

(52) U.S. Cl. 156/314; 524/387; 401/55

(57) ABSTRACT

A composition comprising at least one carrier solvent, at least one primer component and at least one gelling or solidifying agent is provided. The composition according to the invention may he provided in the form of a soft solid, for example, in the form of a stick. A two-part adhesive system is also provided, comprising at least one anaerobic product and a composition comprising at least one carrier solvent, at least one primer component where the primer component is a cure promoting agent and at least one gelling or solidifying agent. A two-part adhesive system comprising a cyanoacrylate adhesive and a composition having at least one carrier solvent, at least one primer component and at least one gelling or solidifying agent is also provided. A pack is provided comprising a shaped mass of a composition which includes at least one carrier solvent, at least one primer component and at least one gelling or solidifying agent, and a container (1) for the composition which has a mechanism for expelling the shaped mass.

### FIELD OF THE INVENTION

The present invention relates to semi-solid primer compositions, particularly well suited to promoting the bonding of substrates, such as those constructed of non-polar or highly crystalline materials or for promoting the cure of otherwise slow curing products.

### BRIEF DESCRIPTION OF RELATED TECHNOLOGY

Primers have long been used to promote the bonding of substrates which otherwise are not readily bonded together to a satisfactory extent by adhesive alone. The primer promotes adhesion to the surface. Materials which do not bond satisfactorily with adhesive alone are often referred to as “difficult-to-bond”. Where both surfaces to be bonded are difficult-to-bond, both may be primed prior to attempted adhesion. Primer is applied to the surfaces to be bonded, to “activate” or “prime” the surface for reception of later applied adhesive. Certain primer components are thus often referred to as adhesion-promoting agents” or “adhesion-promoting primers” as they can promote subsequent adhesion of substrates with a conventional adhesive.

The types of surface (substrate) which are difficult-to-bond with adhesives, especially with cyanoacrylate adhesives, are widely recognised and include non-polar or highly crystalline substrates.

Non-polar substrates typically have low surface energy which is due to an absence of polar groups on the surface to be bonded. Polar groups are generally thought to raise the surface energy to the level needed to give satisfactory adhesion with conventional adhesives.

Non-polar substrates are often constructed of polyolefins in particular linear polymers of simple olefins, such as polyethylene, polypropylene, polybutene, polytetrafluoroethylene and the like, including their copolymers; polyacetals, plasticised PVC (polyvinyl chloride), polyurethane, EPDM (ethylene-propylene diamine monomer) rubber, thermoplastic rubbers based on vulcanised polyolefins and the like.

Difficult-to-bond materials which are widely recognised include those with a waxy or paraffin-like surface character; a low critical surface tension of wetting; and which may have at their surface a weak boundary layer.

It will be appreciated therefore, that the main function of an adhesion-promoting primer is to promote adhesion in cases where curing (polymerization) occurs readily but where adhesion may not take place at all or to a desired extent. As stated above this a scenario typical of cyanoacrylate adhesives.

A second function of a primer composition may be to promote cure of the curable composition. Primer components which have this function are referred to herein as “cure-promoting”. In some instances curable compositions may provide a desired degree of adhesion but achieve adhesion at an undesired rate. For example the curable composition may cure to give sufficient adhesion but may do so only very slowly so that [symbol] bonded must be kept in contact over a period of hours or even longer. While relatively long cure times are desirable in some instances, a shorter cure time without deleteriously affecting bond strength is desirable for many other purposes. Slow cure is a property associated with many products including those termed “anaerobic” products. These are polymerizable products which are stable and remain unpolymerized in the presence of air (oxygen in particular) and which tend to cure rapidly in the absence of air.

It is normal for an initiator component of a cure system to be excluded from the primer composition so that the primer composition is absent an initiator component.

It is known to provide cure-promoting primer compositions for the purpose of decreasing cure times. In such cases the cure-promoting primer is applied (usually by application in solution form as described below) to the desired substrate and the curable composition is then applied to the surface treated with primer. The cure-promoting primer acts to decrease cure times by accelerating the cure of the composition but without for example diminishing bond strength of adhesives, or sealing capability of sealants.

It is possible that any given primer may have dual functionality i.e. promoting adhesion and promoting cure though it is usual for primers to be classified as having one of these main functions.

The present invention is concerned with primers in general including both adhesion-promoting, and cure-promoting primers.

Application of a primer composition which comprises a primer component in a solvent to a substrate to be primed is typically by way of a brush or some such other applicator, to form a layer or coating on the surface. The coating is then typically dried, or allowed to dry for a period, before bonding with adhesive is attempted, and to ensure that the surface is properly primed. In this respect at least for adhesion-promotion primers the solvent is normally a volatile one i.e. evaporates readily at room temperature leaving behind the primer component. The solvent does not therefore interfere with the [symbol] adhesion process—acting only as an inert carrier solvent for placing the adhesion-promoting primer component on the substrate. For cure-promoting primers the solvent may be a polymerizable monomer or oligomer which may take part in the polymerization process during bonding. Accordingly these solvents are not usually considered “inert” in the sense that the participate in the subsequent bonding process. They do however act as carrier solvents for the primer component. Monomeric or oligomeric solvents do not tend to evaporate to any appreciable extent after application so that they are not normally considered volatile. These compositions will most usually be liquid also.

The nature of such primer compositions can result in difficult handling for example unwanted spillage, run-on of the coating applied, and the cumbersome task of having to use an applicator or brush. It is desirable to provide a more easily handled and potentially safer form of primer composition.

Primer compositions typically include at least one priming compound or agent which is the primer component of the composition. Various primer components and primer compositions are described below.

It is desirable therefore to provide a primer composition in a consumer-friendly manner to allow for ease of handling etc. Presenting primer compositions in consumer-friendly forms and/or packages is a difficult task as the primer component must not have its adhesion- or cure-promoting capabilities deleteriously affected by the form, or package, in which it is presented for use.

Various types of adhesive compositions are available commercially ranging from low viscosity (liquid) compositions to gels and other medium viscosity compositions to higher viscosity products such as pastes, and soft-solid products.

It is known to thicken or gel adhesive such as cyanoacrylate adhesives with polymethylmethacrylate or thixotropic agents such as those described in U.S. Pat. Nos. 4,447,607 and 4,533,422 (Litke).

It is also known for instance to formulate adhesives as “stick” compositions. The patent literature on stick adhesives is extensive and covers a broad range of adhesive types, from emulsion adhesives through solvent based adhesives, to contact adhesives, as well as gelling and solidifying additives for the preparation of the sticks ranging from thermosetting through natural polymers to inert fillers. A well known example of one such adhesive stick sold under the trade name PrittStick™ by Henkel KGaA which is an emulsion-based adhesive.

In the patent literature the following patents typify the type of composition in which adhesive components have been formulated as soft-solids, and more particularly sticks. U.S. Pat. No. 5,433,775 discloses an adhesive stick consisting of a water based preparation of starch derivatives and a soap gel as the shaping gel-forming component. See also U.S. Pat. No. 5,371,131.

U.S. Pat. No. 3,846,363 relates to an adhesive crayon composition containing a sorbitol-benzaldehyde reaction product as an additive. U.S. Pat. No. 4,639,475 discloses an adhesive stick composed of the reaction product of sorbitol and/or xylitol and benzaldehyde as the gel-forming composition together with an adhesive resin which is the reaction product of methyl vinyl ether/maleic acid anhydride copolymers with partially neutralised acid phosphate esters of non-ionic wetting agents of the lower alkylene oxide adduct type.

Japanese unexamined patent application laid open (Kokai) 51-103939 describes a stick-like epoxy adhesive and a stick-like epoxy hardening agent which is used therewith. The sticks are obtained by suitably compounding gelling agent or/and water is and/or organic solvent with liquid or solution type epoxy adhesive and epoxy hardening agent.

DE 199 57 677 A1, published after the priority date of the present application, of Henkel KGaA describes a cyanoacrylate adhesive, coating or sealing material which also contains at least one condensation product of an aldehyde or ketone with a polyol. [symbol] may be in stick form.

While a wide variety of sticks have been described, no prior publication has suggested that a primer composition could be made in stick form at all, let alone while maintaining its primer functionality. It would therefore be advantageous to provide a primer composition in stick form.

### SUMMARY OF INVENTION

The present invention provides a primer composition suitable for formulation/presentation in stick form. The primer composition may promote subsequent bonding of non-polar or highly crystalline substrates such as polyolefins, or similar plastics substrates with low surface energy, with adhesive such as cyanoacrylate adhesives. Alternatively or additionally to being adhesion-promoting, the composition may act as a cure-promoting agent to promote cure of the curable product depending on the primer component chosen. The compositions allow for ease of application and/or handling, and allow for accuracy in application without running on of the primer composition.

In particular the present invention provides:

a composition including:

(a) at least one carrier solvent;

(b) at least one primer component; and

(c) at least one gelling or solidifying agent.

The composition is easily cast in stick form and is very useful in his respect. The present invention thus provides primer compositions typically for use with an adhesive. In particular the adhesion-promoting primer compositions of the present invention have been demonstrated as being effective adhesion-promoting agents for example as a cyanoacrylate primer composition which is particularly useful for promoting adhesion of polyolefins. The cure-promoting compositions within the present invention have been shown to be effective as cure-promoting agents particularly with [symbol] adhesives and sealants.

More particularly, the present invention relates to the preparation and use of primer compositions in stick form, to promote the bonding of non-polar or highly crystalline substrates with adhesives, especially with cyanoacrylate adhesives or alternatively to promote cure of curable products in particular to promote the cure of anaerobic products.

The curing or polymerization of a film of adhesive such as cyanoacrylate, between two materials, does not necessarily result in a strong bond, particularly if the materials are non-polar, and if the polymerization of the adhesive is excessively rapid, a very weak bond or no bond will result. The adhesion-promoting compositions of the present invention help to alleviate this non-bonding problem. The cure-promoting compositions of the present invention have been found to promote (accelerate) curing of otherwise slow curing products.

Suitably the composition is the form of a soft-solid. The composition may be formulated in stick form, for example by casting.

Suitably component (a) the carrier solvent comprises an organic solvent in which the primer component is stable. Component (a) may be an organic solvent such as ethanol, methanol, acetone, methyl ethyl ketone, 1,1,1-trichloroethane, 1,1,2-trichloro-1,2,2,-trifuoroethane or mixtures thereof with each other or with other solvents such as an azeotropic mixture of 1,1,2-trichloro-1,2,2,-trifluoroethane with acetone. Desirably the solvent is ethanol. The solvent is desirably an inert carrier solvent where the primer composition is an adhesion-promoting one.

The function of the solvent is to provide a suitable concentration of the primer component so that a coating of selected thickness can be applied to a surface. Therefore, any common solvent in which the primer component is stable will suffice. The solvent will usually dissolve the primer component though dissolving is not essential provided the solvent acts to provide a dilute (and thus disperse) form of the primer component for subsequent application. Certain active primer components used in this invention [symbol] adhesion on non-polar and highly crystalline substrates while certain others promote curing of curable products such as anaerobic adhesives.

Component (c) is suitably the condensation product of the reaction of at least one aldehyde and/or ketone with a polyol.

Suitable polyols include those with at least one of a 1,2-diol, 1,3 diol or 1,4 diol structure. The diols may additionally have other groups such as ether, acid, amido, cyano, hemiacetal or halogen. Examples of suitable polyols include 1,2-ethandiol, 1,3-propandiol, 1,2-propandiol, 2,3-butandiol, 1,4-butandiol, 2,2-dimethyl-1,3-propandiol, 2,2-bis(hydroxymethyl)-1,3-propandiol, 2-(bromomethyl)-2-(hydroxymethyl)-1,3-propandiol, 1,3,4-butantriol, 1-phenyl-1,2,3-propantriol, 1,2-hexandiol, neopentylglycol, 1,4-bishydroxymethylcyclohexane, 2-methyl-1,3-propandiol, hexantriol-(1,2,6), 2-(2-hydroxyethoxy)butan-1,3,4-triol, glycerine, di and polyglycerine, diglycerindiacetate, trimethylolpropane, di-(trimethylolpropane), trimethylolethane, pentaerythritol, bicyclo [2.2.1] heptane-2,3,5,6-tetrol, 2,2,3,3-tetrahydroxybutandiacid, dipentaerythritol, sorbitol, formitol, xylitol, inositol, glucitol, glucose, saccharose/sucrose, starch, cellulose, ascorbic acid, partially or fully hydrolysed polyvinylacetate, 9,10-dihydroxy stearic acid methyl ester, diacetylsorbitol and methylglyceride.

Most suitable polyols are sorbitol, xylitol and mannitol especially sorbitol.

Suitable aldehyde or ketones include those which have at least one substituted or unsubstituted aromatic, heteroaromatic or alicylic ring. These polyols may have additional groups such as ether ester, amide, cyano and halogen.

Examples of ketones include cyclopentanone, cyclohexanone, cycloheptanone, 1-(3,3-dimethylcyclohexyl)-ethanone, 1-cyclopropylethanone, 3-methyl-5-propylcyclohex-2-en-1-one, dicyclopropylmethanone, 4-tert-butylcyclohexanone, dicyclohexylmethanone, 4-methylcyclohexanone, 1-(1-methylcyclopropyl)-ethanone, (4-chlorophenyl)-cyclopropyl-methanone, 1-(1H-pyrrol-2-yl)-ethanone, 1-(2,4,6-trimethylphenyl)-ethanone, 1-(2-furanyl)-2-propanone, 1-(2-naphthalenyl)-ethanone, 1-(2-thienyl)-1-propanone, 1-(4-bromophenyl)-ethanone, 1-(4-methoxyphenyl)-ethanone, [symbol] alenyl)-ethanone, 1,1-diphenyl-2-propanone, 1,2-diphenylethanone, 1,3-diphenyl-2-propanone, 1-phenyl-1-butanone, 1-phenyl-1-decanone, 1-phenyl-1-dodecanone, 1-phenyl-1-hexanone, 1-phenyl-1-octanone, 1-phenyl-1-pentanone, 1-phenyl-1-penten-3-one, 1-phenyl-1-tetradecanone, 1-phenyl-2-butanone, 1-phenyl-2-propanone, 1-pyrazinyl-ethanone, 2,2,2-trifluoro-1-phenyl-ethanone, 1-(2-furanyl)-ethanone, 1-(2-pyridinyl)-ethanone, 1-(2-thienyl)-ethanone, 4-chloro-1-(4-fluorophenyl)-1-butanone, 4-phenyl-2-butanone, 1-phenyl-ethanone, bis-(2-hydroxyphenyl)-methanone, bis-(4-chlorophenyl)-methanone, cyclopentylphenylmethanone, cyclopropyl(4-methoxyphenyl)-methanone, cyclopropyl-(4-methylphenyl)-methanone, cyclopropyl-2-thienyl-methanone, cyclopropylphenylmethanone, 1,5-diphenyl-1,4-pentadien-3-one, phenyl-2-pyridinyl-methanone, 2-bromo-1-(4-nitrophenyl)-ethanone, 2-naphthalenylphenyl-methanone, 3-chloro-1-phenyl-1-propanone, 4-(4-hydroxyphenyl)-2-butanone, 4-(4-methoxyphenyl)-3-buten-2-one, 1-(4-pyridinyl)-ethanone, 1-(4-hydroxyphenyl)-ethanone, 1-phenyl-1-propanone, 4-phenyl-3-buten-2-one, diphenylmethanone, 1-phenyl-2-butanone, 1-phenyl-2-buten-1-one, bis-(4-methylphenyl)-methanone, 2-methyl-1-phenyl-1-propanone, 2-chloro-1-phenyl-ethanone, cyclopropyl-(4-fluorophenyl)-methanone, 1-(p-methoxyphenyl)-2-propanone, cyclohexylphenylmethanone and phenyl-(2-thienyl)-methanone.

The following aldehydes are exemplary for use in the present invention: benzaldehyde, 3-chlorobenzaldehyde, 4-chlorobenzaldehyde, 2,6-dichlorobenzaldehyde, 2,4-dinitrobenzaldehyde, 3,4-dichlorobenzaldehyde, 3-fluorobenzaldehyde, 4-bromobenzaldehyde, 2-methyltetrahydrobenzaldehyde, tetrahydrobenzaldehyde, 2-methyl-5-isopropylcyclopenten-1-aldehyde, 2,2,4-trimethylcyclohexa-4,6-dien-1-aldehyde, 3(4)-methyl-1-propylcyclohexen-3-aldehyde, 1,3(4)-dimethylcyclohexen-3-aldehyde, 2-methyl-1-propylcyclohexen-3-aldehyde, 3-cyclohexen-1-aldehyde, 2,3,4,5,6-pentafluorobenzaldehyde, 2,4,6-trihydroxybenzaldehyde, 4-tolylacetaldehyde, 2-methylbenzaldehyde, 4-hydroxybenzaldehyde, 3-methylbenzaldehyde, 2-hydroxy-1-naphthalaldehyde, 4-methylbenzaldehyde, 3,5-dimethoxy-4-hydroxybenzaldehyde, cinnam-aldehyde, 3-nitrobenzaldehyde, 2-pentylcinnamaldehyde, 4-diethylaminobenzaldehyde, 4-methoxybenzaldehyde, 2-phenylpropionaldehyde, 2-methoxycinnamaldehyde, 4-methylbenzaldehyde, phenoxyacetaldehyde, methylpyrrol-2-aldehyde, 2,5-dimethoxytetrahydrofuran-3-aldehyde, 2,5-dipropyl-3,4-dihydropyran-2- , [symbol] 2,5-diethyl-3,4-dihydropyran-2-aldehyde, 2,5-diisopropyl-3,4 dihydropyran-2-aldehyde, 2,5-dimethyl-3,4-dihydropyran-2-aldehyde, 2,5-dibutyl-3,4-dihydropyran-2-aldehyde, thiophen-3-aldehyde, indol-3-aldehyde, pyridine-3-aldehyde, pyridine-4-aldehyde and n-methylpyrrole-2-aldehyde.

Desirable aldehydes include benzaldehyde, 3-chlorobenzaldehyde and 3-fluorobenzaldehyde.

Particular acetals and ketals include: di-O-benzylidenmannitol, di-O-(2-chlorobenzylidene)mannitol, di-O-(4-nitrobenzylidene)mannitol, di-O-(3-fluorobenzylidene)mannitol, O-benzylidenesorbitol, di-O-benzylidenesorbitoldiacetate, di-O-(2-chlorobenzylidene)sorbitoldiacetate, tri-O-(4-chlorobenzylidene)sorbitol, O-benzylidenethreitol, O-benzylidene tartaric acid methylester, O-cyclohexylidenglycerine, O-cyclohexylidene ascorbic acid and O-benzylidene-9, 10-dihydroxy stearic acid methylester.

Suitably the aldehyde is benzaldehyde, 3-chlorobenzaldehyde or 3-fluorobenzaldehyde especially benzaldehyde. Suitably the polyol is sorbitol, xylitol or mannitol especially sorbitol. The condensation product may be di-O-benzylidene mannitol; di-O-(3-fluorobenzylidene) mannitol or di-O-benzylidene sorbitol especially di-O-benzylidene sorbitol.

Component (c) the gelling or solidifying agent is useful for the preparation of a stick from the solutions containing the adhesion-promoting agent.

Suitable gelling agents for inclusion as component (c) include acetals of sugars, particularly acetals of sorbitol, which are particularly effective as gelling agents. One such gelling agent includes di-O-dibenzylidene sorbitol (also referred to simply as dibenzylidene sorbitol) sold by Roquette Freres, France under the trademark Disorbene™. Other acetals such as those described above have also been found to be useful.

Acetals of sugars, particularly natural sugars, for example acetals of sorbitol, [symbol] previously used as gelling agents for the preparation in stick form and these materials are useful in the present invention.

Suitably component (c) the gelling or solidifying agent has a concentration in the solvent from about 0.01% to about 20%, such as about 0.01% to about 15%, typically from about 0.05% to about 10% for example about 0.1% to about 5% by weight by weight based on the total weight of the composition.

It is desirable that a solution of the active primer component in the solvent should have a concentration of about 0.001 to about 30% by weight based on the total weight of the composition for example from about 0.01 to 20% by weight based on the total weight of the composition. Suitable concentrations are about 0.005 to about 15% such as about 0.005 to about 10% by weight based on the total weight of the composition for example about 0.001 to about 5% by weight based on the total weight of the composition such as 0.01 to about 2% by weight based on the total weight of the composition.

Desirably the primer component is an adhesion-promoting agent.

Suitably (where adhesion-promotion is desired) the primer component is selected from:

(i) 1,5-diazabicyclo[4.3.0]non-5-ene having the formula:

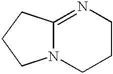

1,8-diazabicyclo[5.4.0]undec-7-ene having the formula:

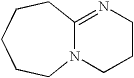

or 1,5,7-triazabicyclo[4.4.0]dec-5-ene having the formula:

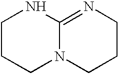

(ii) triphenyl phosphine, or

(iii) ethylenediamine or derivatives of ethylenediamine according to the formula:

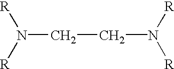

wherein each R, which may be the same or different, represents hydrogen, an alkyl, alkenyl or alkoxy group having 1 to 8 carbon atoms, an aryl group having 6 to 8 carbon atoms, a nitrogen-, sulphur-, or silicon-substituted group having up to 8 carbon atoms or a heterocyclic group having up to 8 carbon atoms which may be unsubstituted or substituted with hydroxy, ether oxygen or sulphur; or

(iv) an imidazole having the formula:

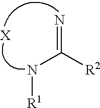

wherein R¹ may be hydrogen; an alkyl group that is unsubstituted or substituted with an OH group or with an (alkyl-O)₃Si group, wherein the alkyl radical has 1 to 4 carbon atoms; an aryl-alkyl group with 7 to 10 carbon atoms; or an imidazole-CO group, and R² may be hydrogen or an alkyl, aryl, or aryl-alkyl group with up to 17 carbon atoms, with the condition that one of the substituents R¹ or R² has an aromatic character and X is one of the groups —CH═CH— or —CR³R⁴—CR⁵R⁶— wherein R³, R⁴, R⁵ and R⁶ independently of one another represent hydrogen, an alkyl group with 1 to 4 carbon atoms, or an aryl-alkyl group with up to 17 carbon atoms.

Suitably (again particularly where adhesion promotion is sought) the primer component (component (b)) contains at least two nitrogen atoms. Desirably the primer component is a compound of the group (i) above, in particular 1,8-diazabicyclo[5.4.0]undec-7-ene.

From among the ethylenediamines labelled as primer component (iii) above, suitable ethylenediamines are those according to the formula give above wherein each R, which may be the same or different, represents hydrogen, an alkyl, alkenyl or alkoxy group, having 1 to 8 carbon atoms, an aryl group having 6 to 8 carbon atoms, a nitrogen- or sulphur-substituted group having 1 to 8 carbon atoms or a heterocyclic group having up to 8 carbon atoms which may be unsubstituted or substituted with hydroxy, ether oxygen or sulphur.

Desirably ethylenediamine primer components are those wherein at least one R is aryl, or each R is other than hydrogen and at least one R is other than methyl.

Desirably the composition comprises as primer components one or more of: N,N,N′,N′-tetraethylethylenediamine and at least one of N′-benzyl-N,N′dimethylethylenediamine, N,N-diethyl-N′phenylethylenediamine, N,N′-dibenzyl-N,N′-dimethylethylenediamine or N-2-aminoethyl-3-aminopropyl-bis(2-ethylhexoxy)-silane.

Examples of the primer component labelled as (iv) above include the imidazole compounds include: those derivatives where X is —CR₃R₄—CR₅R₆- especially 4,5 dihydroimidazole; these compounds may also be referred to as imidazolines.

Desirable primer components include those imidazole compounds referred to above where X is —CR₃R₄—CR₅R₆—, R_{1, R2,} R_{3,}, R₄, R₅ and R₆ desirably have the following significance: R₁ is hydrogen or a hydroxyalkyl group, R₂ is an aryl or an aryl-alkyl group with to 17 carbon atoms and R₃, R₄, R₅, and R₆ independently are each hydrogen or an alkyl group with 1 to 4 carbon atoms. More desirably R₁ is hydrogen or a hydroxyethyl group, R₂ is a benzyl or phenyl group, and R₃, R₄, R₅ and R₆ are hydrogen. A particularly advantageous imidazoline derivative for use in the invention is 2-phenyl-

[symbol]

Typical examples of aryl or aralkyl groups that can be the substituent R₂ are phenyl, naphthyl, tolyl, xylyl, benzyl, and naphthylmethyl groups. Typical examples of alkyl groups with 1 to 17 carbon atoms that can likewise form the R₂ group are methyl, ethyl, propyl, butyl, pentyl, heptyl, nonyl, undecyl, tridecyl, pentadecyl, and heptadecyl groups; straight chain alkyl groups are most useful. In addition, mixtures of these 2-alkylimidazole derivatives can also be used, containing alkyl groups of different chain lengths from the above list. Typical examples of alkyl groups with 1 to 4 carbon atoms and aryl groups that can form the substituents R₃, R₄, R₅ and R₆ can be obtained from the above list.

When X is —CH═CH—, R₁ and R₂ desirably have the following significance; R₁ is an aryl group with 7 to 10 carbon atoms or an imidazole-CO group and R₂ is hydrogen or an alkyl group with 1 to 4 carbon atoms. Most desirably R₁ is a methyl or benzyl group and R₂ is hydrogen or a methyl group.

Other imidazole primer compounds useful in the present invention include those of the Formula:

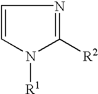

wherein R¹ is a C₁-C₄ alkyl group optionally substituted with a phenyl group, and R² is hydrogen or a C₁-C₄ alkyl group.

Desirably the composition when solidified has the consistency of a soft-solid or waxy mass. The Theological properties of the mass of product should be such that the mass has a stable geometric shape. It is desirable that the shaped mass e.g. a stick, is applicable by manual rubbing against the substrate to which it is to be applied. The soft or semi-solid mass should be shearable under relatively modest manual pressure to [symbol] ease of application. Under shear forces the solid may liquify to form a film (or smear) of the composition on the surface. It is desirable that the shaped mass retains its shape, for example when stored at 20° C. for a number of days for example at least about 10 days, more desirably for a number of weeks or months. The composition exemplified herein have proven to be stable over a number of months in such conditions. The cast composition has the ease of handling advantages of a completely solid material yet remains easily dispensable. PrittStick™ is one commercially available semi-solid mass sold as an adhesive stick which is well known as a dispensable adhesive.

The primer composition composed of one of the above primer components as a solution in a (solidified) solvent is normally of such concentration that the thickness of the coating can be controlled to achieve the full effects of this invention.

The present invention also provides a composition described above wherein the primer component is a cure-promoting agent. Suitably the cure-promoting primer component is selected from substituted thioureas, a compound having a sulphur-containing free radical source, a compound containing an oxidisable transition metal or a compound containing one of the groups

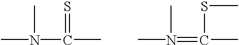

Most desirable are compositions wherein the primer component is a compound containing an oxidisable transition metal. The transition metal is desirably selected from those elements in the groups (columns) of the Periodic Tables containing Cr, Mn, Fe, Co or Cu. The transition metal may be selected from Cu, Cr, Co, Fe, and Mn, more particularly Cu(I), Cu(II), Co(II), Mn(II), Mn(III) or Cr(II). Particularly useful are those where the transition metal is selected from Cu(I) or Cu(II), especially those compounds which are salts of these particular forms of Cu, for example salts of carboxylic acids, beta diketones or beta keto esters. Particular salts are Cu(II) 2-ethylhexanoate or Cu(II) acetylacetone.

Where the primer component is a cure-promoting primer for anaerobic products [symbol] may be a polymerizable monomer or polymerizable oligomer for example alkyl methacrylate esters such as methyl or ethyl methacrylate. In the embodiment the polymerisable monomer or oligomer may interact with the polymerization process and thus form part of the cured product. The monomer or oligomer should provide the desired concentration of primer component. The solvent may thus for example be methyl or ethyl methacrylate.

The invention also provides a two-part adhesive system comprising (i) at least one cyanoacrylate adhesive and (ii) an adhesion-promoting primer composition according to the present invention as defined above. Suitably the cyanoacrylate is an alpha cyanoacrylate.

Suitable cyanoacrylate adhesives for use with the adhesion-promoting primer of this invention are represented by the general formula

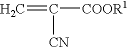

wherein R¹ is alkyl, alkenyl, cycloalkyl, aryl, alkoxyalkyl, aralkyl, haloalkyl or another suitable group. The lower alkyl alpha-cyanoacrylates are preferred, and in particular methyl, ethyl, n-propyl, n-butyl, isobutyl, isopropyl, allyl, cyclohexyl, methoxyethyl or ethoxyethyl cyanoacrylates are preferred. Many alpha cyanoacrylates can be obtained commercially as one component instant adhesives, in which form they may be used in a method of assembly of this invention.

The present invention also provides a two-part adhesive system comprising (i) at least one anaerobic product and (ii) a cure-promoting composition as described above. Suitable anaerobic products are described below.

The invention also relates to the solidified product of a composition as described above. Suitably the composition is solidified in a desired geometric form, for example in a cylindrical shape. Any suitable shape which allows for ease or handling is desired and such shapes are typically referred to as sticks. One method of preparing a soft-solid or semi solid mass of the composition includes the steps of:

(i) heating a composition comprising (a) at least one carrier solvent; (b) at least one primer component; and (c) at least one gelling or solidifying agent, to a desired temperature; and

(ii) allowing the composition to cool or cooling the composition sufficiently to set the composition.

Typically the composition will set (solidify to a soft-solid) at a temperature of below about 30° C. for example at about 15-22° C.

The invention also relates to a shaped mass prepared by the method just described and particularly a mass shaped in a stick form.

While these commercially available cyanoacrylates are composed principally of alpha cyanoacrylate monomer, the formulation may contain stabilisers, thickeners, adhesion-promoters, plasticizers, dyes, heat resistant additives, impact resistance modifiers, perfumes, diluents and such like. These adjustments may also be used with anaerobic products.

It will be appreciated that if the composition is cast before cooling to its set temperature then it will take the shape of the container or mould in which it is cast. It is desirable that the composition be cast in a desired geometric shape for example as a stick for example a stick of a generally cylindrical shape. The person skilled in the art will appreciate that the pre-and post-casting composition will have essentially the same compositional make-up, with mainly physical changes from liquid to solid occurring during casting. Little or no solvent will be lost during the casting process. The amounts of the various components thus remains essentially unchanged as between the liquid and solidified compositions. No appreciable volume change occurs during casting.

In a further aspect the invention provides a method of bonding a first (non-polar) [symbol] to a second substrate (which may be polar or non-polar), which comprises treating (by priming) the first (non-polar) substrate(s) by applications of a composition according to the present invention, applying a cyanoacrylate (suitably an alpha cyanoacrylate) adhesive to the treated surface(s) and contacting the substrates for sufficient time (and with sufficient pressure) to allow them to bond to each other. In this way a bonded assembly is created. In the case where the substrates to be bonded are both non-polar or otherwise difficult-to-bond materials of that type, both substrates may be primed with a composition of the invention. The composition may suitably be applied by (manually) rubbing the primer stick on the substrate. If the non-polar substrate is to be bonded to a polar or more active substrate, only the non-polar substrate needs to have applied the primer. Following application of the primer to the non-polar substrate(s), the bond may be completed using cyanoacrylate adhesive in the normal manner. This method is especially useful for priming polyolefin substrates. This method may also be used with anaerobic products where the substrate to which the product is applied is not necessarily a non-polar one. Anaerobic products may seal between rather than bond together two substrates.

The invention relates also to a bonded assembly created by this method. The invention thus discloses the use of a primer composition in the manufacture of a castable primer stick composition for example a primer stick for priming substrates (for subsequent bonding with adhesive). The adhesion-promoting compositions of the invention may be used to prime non-polar or highly crystalline substrates.

The invention also provides an easy to use and consumer-friendly pack comprising:

(i) a shaped mass of a composition according to the invention (a cast composition); and

(ii) a container for the composition, the container having a mechanism for expelling the shaped mass. Desirably the shaped mass is moveable between a position where the shaped mass projects from the container, and a position where the shaped mass is substantially located (retracted) within the container.

The composition may be cast directly in the container. Normally the container [symbol] bular and most often of cylindrical shape. The container may be of the type having a displaceable mechanism for example a carrier for displacing the mass of the composition relative to the container. The carrier may move the mass so that it projects from the container, or retract the mass so that it is housed within the container. In this way the mass may be extended for application to a substrate or retracted for storage. The container may comprise a cap for protection of the mass when the composition is not in use. Desirably the container has means for manual adjustment of the position of the mass or carrier, for example where the carrier is reciprocally threaded on a winding mechanism and can thus be extended or retracted by rotation of the winding mechanism in one of two directions.

It will be appreciated by those skilled in the art that a multitude of suitable containers may be used with the shapes masses or sticks of the present invention. Typically used containers are those with propulsion mechanisms to propel the stick out of the container. Many such containers are known for example for deodorants/anti-perspirants, and make-up such as lipstick etc.

### BRIEF DESCRIPTION OF THE FIGURES

FIG. 1 is a side (part-sectional) elevational view of a container suitable for holding the composition of the present invention; and

FIG. 2 is a top view of a carrier which forms part of the container of FIG. 1.

### DETAILED DESCRIPTION OF THE INVENTION

Many primer components and primary compositions have been developed for use in bonding of substrates, in particular difficult-to-bond substrates as described above. Some primers components and primer compositions are now discussed. In accordance with the present invention the primer components disclosed below in the documents discussed may be taken and formulated in a composition of the present invention for casting in stick form.

For example, Japanese patent application Nos. 52-98062, 56-141328 and 57-119929 suggest the use of primers prepared by dissolving a chlorinated polyethylene or chlorinated polypropylene or a fatty acid modified acrylated alkyd resin in an organic acid.

Primer based or organometallic compound are also known. For instance, European patent application no. 0 129 069 A2 discloses the use of a primer comprising at least one organometallic compound, for use with alpha cyanoacrylate adhesives, which is useful in bonding non-polar substrates. Japanese patent application No. 61023630 proposes organometallic primers for joining plastic models. U.S. Pat. Nos. 5,292,364, 5,110,392 and 4,818,325 also disclose the use of primer compositions containing organometallic compounds for use with cyanoacrylate adhesives.

Primers for polyolefins comprising (i) modified or grafted polyolefins such as chlorinated polyolefins, ethylene/vinyl acetate copolymer or ethylene/propylene terpolymer, (ii) a crosslinking binder and (iii) crosslinking agents, are disclosed in European application No. 0 187 171A. German application No. DE 3601518-A suggests the use of primers for polyolefins comprising an organometallic compound and an organic polymer; the organometallic compound being a metal alcoholate and the term “metal” including metalloids, phosphorous, boron or silicon atoms Japanese application No. 61136567 describes a titanate primer for bonding polypropylene.

The English language abstract [from JAPIO database, accession no.1987-018486] for Japanese application No. 60157940 discloses a primer composition based on a solution of 4-vinyl pyridine as an essential ingredient, and 3,4-lutidine as an optional ingredient, for bonding polyolefins, polyacetal, polyamide, polyester, boron-polymer, silicone or PVC.

The Derwent Abstract [Accession no. 1994:559135] for Japanese patent application JP 610 0839 discloses dialkylamino diazabicycloundecene primer compositions for use with cyanoacrylate adhesives for plastics bonding. For example polyolefins and EPDM. The compounds, are those of formula I below

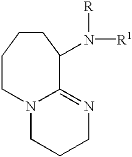

(R, R¹=C₁₋₁₄ alkyl, benzyl).

U.S. Pat. No. 5,314,562 describes a method for bonding substrates, one of which is a plastic, comprising (a) applying to the plastic substrate a primer solution of an adhesion-promoting ethylenediamine compound dissolved in a solvent, (b) allowing the primer solution to dry, (c) applying an alpha cyanoacrylate adhesive to one of the substrates and (d) joining the substrates. The active adhesion-promoting agent is dissolved in a solvent and applied as a primer solution.

German patent publication no. DE 40 35 680 describes imidazole derivatives which are useful as adhesion-promoting agents.

German patent publication DE 40 17 802 A1 also relates to imidazole derivatives which are useful primers for inclusion in the compositions of the present invention. In particular the document discloses primer compounds of the Formula:

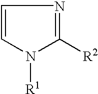

wherein R¹ is a C₁-C₄ alkyl group optionally substituted with a phenyl group, and R² is hydrogen or a C₁-C₄ alkyl group.

The Derwent Abstract [Accession no. 1994-107035] for Japanese patent application JP-A-6057218 discloses a primer composition containing a tert-amine, where the three groups are each a hydrocarbon group, but at least one among them is a long chain hydrocarbon group containing 8 to 24 carbon atoms. The active adhesion-promoting agent is applied by dissolution in isopropanol. WO 91/18956 discloses imidazole derivatives such as 1-benzyl-2-methylimidazole, 1-benzylimidazole, 1-(2-thyl)-2-phenyl-4,5-dihydroimidazole, 2-phenyl-4,5-dihydroimidazole, and N,N′-carbonyldiimidazole, for use as primers in the bonding of plastics, including polyolefins, with cyanoacrylate adhesives.

U.S. Pat. No. 4,869,772 discloses di- and tri-azabicyclo primer compositions for use in bonding non-polar substrates. The active adhesion-promoting agents are dissolved in a solvent, applied as a solution, and allowed to dry leaving the adhesion-promoting agent on the substrate before subsequent bonding with cyanoacrylate.

EP 0 333 448 (equivalent to U.S. Pat. No. 5,079,098) discloses primer solutions (in low surface tension organic solvents) of quaternary ammonium compounds of the formula: R₄N⁺ A⁻ where R is alkyl, hydroxyalkyl, aryl, alkaryl, aralkyl, and alkenyl, optionally substituted by heteroatoms; A⁻ is an anion with pKa>0 in deprotonation equilibrium reactions.

Anaerobic products with which certain primer compositions (in particular cure-promoting primer components) of the present invention are useful include polymerizable compositions which are often in the liquid state. The (polymerizable) anaerobic product remains unpolymerized in the presence of air but polymerizes upon exclusion of air. This property of anaerobic products finds application as for example a sealant between closely fitting metal surfaces. Anaerobic product placed between closely fitting metal surfaces such as flanges cures due to a lack of air.

Anaerobic products such as adhesives and sealant compositions are known in the art. Examples of documents which describe these products include U.S. Pat. Nos. 2,895,950, 3,043,820, 3,218,305 (all to Krieble) and 4,287,330 (Rich) the entire contents of each of which is expressly incorporated herein by reference.

In particular U.S. Pat. Nos. 2,895,950 and 3,043,820 disclose anaerobic sealant compositions comprising polymerisable compounds of the formula:

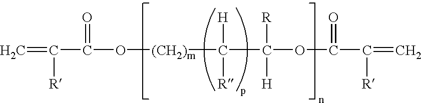

where R is selected from hydrogen, —CH₃, —C₂H₅, —CH₂OH, and

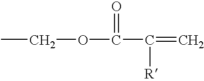

radicals, R′ is selected from hydrogen, chlorine, methyl and ethyl radicals; R″ is selected from hydrogen, —OH radical, and

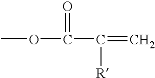

radicals; m is an integer equal to at least one, e.g. from 1 to 8 or higher, for instance from 1 to 4, inclusive, n is an integer equal to at least 2, for example from 2 to 20 or more, inclusive, and p is 0 or 1. Anaerobic compositions including these polymerizable compounds are useful in conjunction with the primer compositions of the present invention in particular those primer compositions of the present invention identified as being cure-promoting.

U.S. Pat. No. 3,218,305 discloses anaerobic products containing polmerizable compounds of the formula:

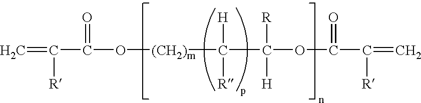

where R is a radical selected from hydrogen, C₁-C₄ alkyl, or C₁-C₄ hydroxyalkyl or

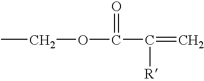

radicals, R′ is selected from hydrogen, halogen, and C₁-C₄ alkyl; and [symbol] , m, n and p, are as defined above. Anaerobic compositions including these polymerizable compounds are useful in conjunction with the primer compositions of the present invention in particular those primer compositions of the present invention identified as being cure-promoting.

In particular polymerizable compounds useful in the present invention may be:

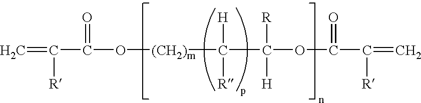

where R is a radical selected from hydrogen, C₁-C₄ alkyl, or C₁-C₄ hydroxyalkyl or

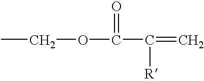

radicals, R′ is selected from hydrogen, halogen, and C₁-C₄ alkyl, OH; and R″ is selected from hydrogen, —OH radical, and

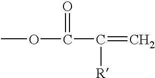

radicals; m is an integer equal to at least one, e.g. from 1 to 8 or higher, for instance from 1 to 4, inclusive, n is an integer equal to at least 2, for example from 2 to 20 or more, inclusive, and p is 0 or 1.

These polymerisable compounds are typically formulated in a composition which contains at least sufficient components to make the composition curable. The person skilled in the art will, depending on the polymerizable monomer selected, consider any further appropriate components. Typical further components for inclusion include an initiator which may independently initiate or assist initiation of polymerization in the absence of air. These initiators are often oxidising agents. These initiators include peroxides for example hydroperoxides such as cumene hydroperoxide.

A further component which may be added is a reducing agent. Typical reducing agents include tertiary amines and for instance U.S. Pat. No. 4,287,330 (Rich) discloses rhodanine and organic hydrazines which are effective accelerators for the cure of anaerobic compositions. Other suitable reducing agents are well known to those skilled in the art. Another potential component is a co-catalyst (for example saccharine) which may catalyse polymerization of the polymerizable compounds.

Suitable compositions for use with primer compositions of the present invention are described in detail in our co-pending Irish application entitle “SEMI-SOLID ONE- AND TWO-PART COMPOSITIONS” filed on even date herewith in the name of Loctite (R&D) Limited.

The use of primer solutions to facilitate more rapid cure, greater through depth cure, or improve adhesion to substrates has been considered also for anaerobic products. These primer solutions have been proposed in particular for use on substrates which do not have readily leachable metal ions or polar groups to facilitate effective adhesion. U.S. Pat. Nos. 4,990,281 (Clark), 3,970,505 (Hauser), 3,591,438 (Toback), 3,625,930 (Toback), among others disclose the use of various types of primers. The teaching of each of these documents is expressly incorporated herein by reference. A common feature of all these primer composition is that the active ingredient is contained in a solvent and the primer solution has to be applied from the liquid state with a variety of techniques.

The '505 patent teaches the use of in particular a substituted thiourea (in conjunction with an acid) as a cure accelerator for anaerobic products. The substituted thiourea (optionally together with the acid) can be used as a primer to activate the surface to which it is desired to apply anaerobic product. The substituted thiourea can be formulated (optionally together with the acid) in a primer composition of the present invention.

The '438 patent teaches the use of a reducing activator which is either a sulphur-containing free radical accelerator, or a compound containing an oxidizable transition metal. The compounds containing an oxidizable transition metal are especially useful in compositions of the present invention and includes those compounds containing the following transition metals: Cu, Cr, Co, Fe, and Mn. Desirable compounds include salts and complexes of these metals including mono- or poly-nuclear and homo- or hetero-nuclear compounds.

Other transition metal-based compounds are disclosed in the '281 patent are desirable for inclusion. These include Cu(II), Co(II), Mn(II), Mn(III) and Cr(II) based compounds in particular salts of these metals. The '281 patent is particularly concerned with the salts of these metals with acid phosphate acrylic monomer. Particular acid phosphate acrylic monomer disclosed include those of the formula:

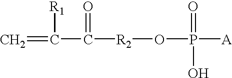

where R₁ is H or methyl, R₂ is a divalent organic group having from 2 to 20 carbon atoms and the group A is OH or

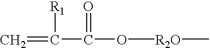

where R₁ and R₂ are as defined for the formula immediately above.

Suitable metal compounds include copper (I) and (II) salts in particular those of carboxylic acids or those of beta diketones or beta keto esters. Specific examples include for example Cu(II) 2-ethylhexanoate and Cu(II) acetylacetonate.

A representative of a Cu(II) based primer is Loctite product “Primer N™”.

Other anaerobic products commercially available from Loctite Corporation Rocky Hill Connecticut, US include the following products sold under the following trade names Loctite 636, Loctite 326, Loctite 648, Loctite 270, and Loctite 290.

The '930 patent discloses a primer composition for anaerobic adhesives which contains as accelerator a compound having one of the following groups:

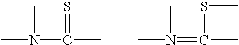

These compounds are also suitable for use with the primer compositions of the present invention.

A container for holding a cast (solidified) composition of the invention is now described.

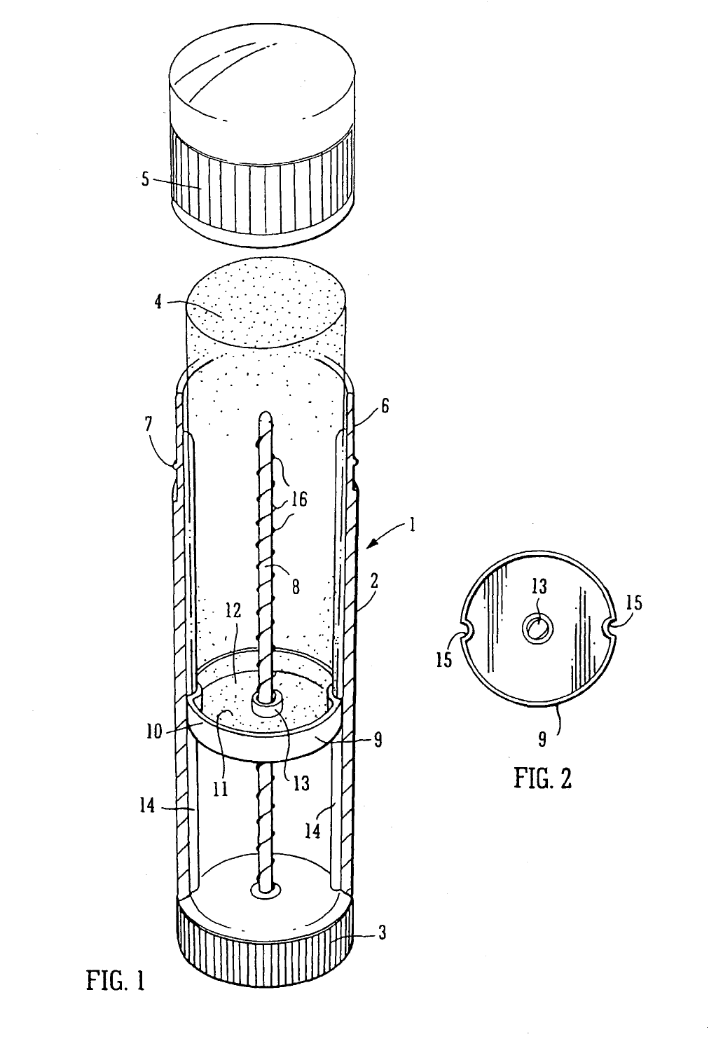

FIG. 1 shows a side view of a container 1 suitable for holding a composition of the present invention. The container is cylindrical in cross-section having cylindrical side walls 2. On the base of the container is a knurled wheel 3 which forms part of a propulsion mechanism for a (soft-solid or semi-solid) mass or stick 4 of the primer composition of the present invention. The mass 4 has been cast in a generally cylindrical shape as described in the Examples below. The container further comprises a cap 5 which is snap-fit engageable over the top end 6 of the container 1 to protect the mass 4 of product. The top end 6 is of lesser diameter than the side walls 2 and has a rim 7 which engages in a corresponding recess on the underside of the cap 5 to secure the cap 5 in place.

The knurled wheel 3 is attached to an elongate drive or winding shaft 8 which is centrally located within the housing formed by the side walls of the container. On the winding shaft 8 is located a moveable carrier 9. The carrier 9 is generally cylindrical (from an end view thereof—see for example FIG. 2) and has a short peripheral upstanding wall 10 formed on its base 11. During the casting process the carrier 9 is positioned to secure itself to the lower end 12 of the mass 4 on solidification of the mass 4. Indeed the mass 4 may be cast also with the shaft 8 (and optionally the wheel 3) in place. As best seen from FIG. 2 the carrier 9 has a central threaded aperture 13 in which the threads 16 of the shaft 8 engage. The knurled wheel 3 and the shaft 8 are both [symbol] for relative rotation to the container body. When the wheel 3 is turned in the direction of the arrow it moves the carrier up or down the shaft 8 thus controlling the relative position of the mass and the container. In the position shown the carrier has travelled part way up the shaft, moving the mass to a position where it protrudes from the container. The mass can then be applied by rubbing against a substrate by manual force. Sufficient shearing of the mass takes place to allow it to rub off onto the substrate. No separate applicator/brush etc. is necessary. The composition can be applied with manual pressure. To prevent rotation of the carrier 9 with the shaft, elongate ribs 14 are provided on opposing sides of the internal wall of the container. The ribs 14 run from the base of the container to a position proximate to the mouth if the container. The ribs 14 each engage one of corresponding grooves 15 in the carrier 9 thus preventing relative rotation of the container and the carrier and ensuring that the carrier moves upwardly or downwardly when the shaft 8 turns. The carrier 9 and the mass 4 can be retracted by rotation of the wheel 3 in an opposing direction.

The words “comprises/comprising” and the words “having/including” when used herein with reference to the present invention are used to specify the presence of stated features, integers, steps or components but does not preclude the presence or addition of one or more other features, integers, steps, components or groups thereof.

The following examples will serve to illustrate the invention.

### EXAMPLES

General

In the following examples the dibenzylidene sorbitol used was the product Disorbene™ described above.

Bonding tests were carried out using various substrates, including natural polyethylene and natural polypropylene as the non-polar substrates, various solutions of the active adhesion promotion compounds as the primer and various grades of cyanoacrylate adhesive commercially available from Loctite (Ireland) Limited, Dublin, Ireland. The bond strength of the resulting joints was determined using conventional [symbol] following standard test method ASTM D 1002.

The 3 kg Test as described below is the minimum time following assembly for bonds to support a 3 kg weight. The minimum time is determined in accordance with ASTM D1002.

### Example 1

2.0 g of dibenzylidene sorbitol was dissolved in refluxing ethanol (148 g) with vigorous stirring and the solution allowed to cool for a short period. Then 1,8-diazabicyclo[5.4.0]undec-7-ene (0.15 g) was added with stirring and the solution was allowed to cool further. The solution was then cast into empty stick cartridges of the type typically used for adhesives such as PrittStick™ (and as described above) and was allowed to cool to room temperature. During this time the solution solidified. The solidified stick was clear (homogeneous) resembling a frozen mass. The solid stick primer solution could then be extruded using the cartridges inbuilt propulsion mechanism.

Test pieces of natural polyethylene of dimensions 100 mm×25 mm and 3 mm in thickness were carefully deburred and degreased with acetone. The aforementioned solid stick primer composition was applied to the polyethylene test pieces by carefully rubbing the prepared primer stick against the polyethylene surface. The coated (primed) surface was allowed to dry for at least 30 seconds before two such test pieces were bonded with a cyanoacrylate adhesive (Loctite product no. 406). The overlap area was 1.61 cm². Adhesive joints assembled as outlined were found to have fixtured within 5-10 seconds.

### Example 2

1.5 g of dibenzylidene sorbitol was dissolved in refluxing ethanol (100 g) with vigorous stirring and the solution allowed to cool for a short period. Then 1,8-diazabicyclo[5.4.0]undec-7-ene (0.2 g) was added with stirring and the solution was allowed to cool further. The solution (a) was then cast into empty stick cartridges and allowed to cool to room temperature. During this time the solution solidified. The [symbol] stick was clear (homogeneous) resembling a frozen mass. The solid stick primer solution could be extruded using the cartridges' inbuilt propulsion mechanism. Similar solutions and sticks were then prepared adding 1,8-diazabicyclo[5.4.0]undec-7-ene (DBU) at the following quantities:(b) 0.5 g, (c) 1.0 g, (d) 2.0 g, (e) 5.0 g. The primer sticks (a)-(e) were tested as primers with a cyanoacrylate adhesive on polyethylene to polyethylene(PE/PE), polypropylene to polypropylene(PP/PP) and on Teflon to Teflon (PTFE/PTFE) following the procedures outlined in Example 1. The results are presented in the following table:

| | | Tensile Shear Bond Strengths | | |
|---|---|---|---|---|
| | | MPa | | |
| Stick | DBU % | PE/PE | PP/PP | PTFE/PTFE |
| (a) | 0.2 | 0.6 | 0.6 | n.a. |
| (b) | 0.5 | 0.6 | n.a. | n.a. |
| (c) | 1.0 | 1.8 | 0.7 | 0.2 |
| (d) | 2.0 | 1.7 | 2.45 | n.a. |
| (e) | 5.0 | 3.3 | 3.3 | n.a |

n.a. = result not available

### Example 3

1.5 g of dibenzylidene sorbitol was dissolved in refluxing ethanol (100 g) with vigorous stirring and the solution allowed to cool for a short period. Then 1,5-diazabicyclo[4.3.0]non-5-ene (1.0 g) was added with stirring and the solution was allowed to cool further. The solution (a) was then cast into empty stick cartridges of the type typically used for stick adhesives and was allowed to cool to room temperature. During this time the solution solidified. The solidified stick was clear (homogeneous) [symbol] a frozen mass. The solid stick primer solution could then be extruded using the cartridges inbuilt propulsion mechanism. A similar solution and sticks were prepared adding 1,5diazabicyclo[4.3.0]non-5-ene (DBN) at the following quantity:(b) 5.0 g. The primer sticks (a) and (b) were tested as primers with a cyanoacrylate adhesive on polyethylene to polyethylene(PE/PE), polypropylene to polypropylene(PP/PP) following the procedures outlined in Example 1. The results are presented in the following table.

Tensile Shear Bond
Strengths MPa

| Stick | DBU % | PE/PE | PP/PP |
|---|---|---|---|
| (a) | 1.0 | 0.9 | 0.5 |
| (b) | 5.0 | 2.2 | 1.1 |

### Example 4

1.5 g of dibenzylidene sorbitol was dissolved in refluxing ethanol (100 g) with vigorous stirring and the solution allowed to cool for a short period. Then triphenyl phosphine (0.5 g) was added with stirring and the solution was allowed to cool further. The solution (a) was then cast into empty stick cartridges of the type typically used for adhesives, and allowed to cool to room temperature. During this time the solution solidified. The solidified stick was clear (homogeneous) resembling a frozen mass. The solid stick primer solution could be extruded using the cartridges' inbuilt propulsion mechanism. Similar solutions and sticks were prepared adding triphenyl phosphine (PPh₃) at the following quantities:(b) 2.0 g, (c) 5.0 g. The primer sticks (a)-(c) were tested as primers with a cyanoacrylate adhesive on polyethylene to polyethylene(PE/PE), polypropylene to polypropylene(PP/PP) and on Teflon to Teflon (PTFE/PTFE) following the procedures outlined in Example 1. The results are presented in the following table.

| | | Tensile Shear Bond Strengths | | |
|---|---|---|---|---|
| | | MPa | | |
| Stick | PPh₃ % | PE/PE | PP/PP | PTFE/PTFE |
| (a) | 0.5 | 0.5 | 0.4 | 0.2 |
| | 1.0 | 0.3 | 0.3. | n.a. |
| (c) | 5.0 | 2.4 | 1.9 | n.a |

n.a = result not available

### Example 5

1.5 g of Dibenzylidene Sorbitol was dissolved in refluxing ethanol (100 g) with vigorous stirring and the solution allowed to cool for a short period. Then 7.5% copper naphthenate solution in hydrocarbon oil( 1.0 g) was added with stirring and the solution was allowed to cool further. The solution was then cast into empty stick cartridges of the type typically used for adhesives, and allowed to cool to room temperature. During this time the solution solidified. The solidified stick was clear (homogeneous) resembling a frozen mass. The solid stick primer solution could be extruded using the cartridges' inbuilt mechanical devices. The primer sticks were tested for primer functionality with a Loctite anaerobic product adhesive Loctite 326 on as received mild steel(ARMS), grit blasted mild steel (GBMS), as received aluminium(ARA) and grit blasted aluminium(GBA) laps of dimensions 100 mm×25 mm and 2 mm in thickness which were carefully degreased with acetone. The aforementioned adhesive primer solution was applied to the test pieces by carefully rubbing the primer stick against the surface. The coated surface was allowed to dry for at least 30 seconds before two such test pieces were bonded with an anaerobic adhesive (Loctite 326). The results are presented in the following tables:

3 kg Fixture Times

| | Primed | No Primer |
|---|---|---|
| ARMS/ARMS | 25 seconds | 12 minutes |
| GBMS/GBMS | 25 seconds | 50 minutes |
| ARA | 40 seconds | 12 minutes |
| GBA | 30 seconds | n.a. |

n.a = result not available

Bond Strengths/
MPa

| | Primed | No Primer |
|---|---|---|
| ARMS/ARMS | 9.4 | 5.2 |
| GBMS/GBMS | 13.7 | 7.3 |
| ARA | 10.1 | 4.2 |
| GBA | 12.5 | 10.5. |

n.a = result not available

### Example 6

1.5 g of dibenzylidene sorbitol was dissolved in refluxing ethanol (100 g) with vigorous stirring and the solution allowed to cool for a short period. Then 6% iron naphthenate solution in hydrocarbon oil(1.0 g) was added with stirring and the solution was allowed to cool further. The solution (a) was then cast into empty stick cartridges of the type typically used for adhesives, and allowed to cool to room temperature. During this time the solution solidified. The solidified stick was clear (homogeneous) resembling a frozen mass. The solid stick solidified and the solid stick primer solution could be extruded using the cartridges inbuilt mechanical devices. The primer sticks were tested for primer functionality with a Loctite anaerobic adhesive Loctite 326 on as received mild steel(ARMS), grit blasted mild steel (GBMS),as received aluminium(ARA) and grit blasted aluminium(GBA) laps of dimensions 100 mm×25 mm and 2 mm in thickness which were carefully degreased with acetone. The aforementioned adhesive primer solution was applied to the test pieces by carefully rubbing the primer stick against the surface. The coated surface was allowed to dry for at least 30 seconds before two such test pieces were bonded with an anaerobic adhesive (Loctite 326). The results are presented in the following tables:

Bond Strengths/
MPa

| | Primed | No Primer |
|---|---|---|
| ARMS/ARMS | 9.5 | 5.2 |
| GBMS/GBMS | 12.1 | 7.3 |
| ARA | 6.7 | 4.2 |
| GBA | 10.3 | 10.5 |

### Example 7

The adhesive primer as described in Example 5 was tested on a range of substrates with another Loctite anaerobic adhesive Loctite 648 giving the following results which demonstrate the ability of the stick primers to shorten the 3 kg fixture times.

3 kg Fixture Times

| Loctite 648 | Primed | No Primer |
|---|---|---|
| ARMS/ARMS | 11 minutes | 35 minutes |
| GBMS/GBMS | 8 minutes | 25 minutes |
| GBA | 10 minutes | 26 minutes |

### Example 8

1.5 g of Dibenzylidene Sorbitol was dissolved with refluxing in Loctite Primer N™ (100 g) with vigorous stirring and the solution allowed to cool for a short period. The solution was then cast into empty stick cartridges of the type typically used for adhesives, and allowed to cool to room temperature. During this time the solution solidified. The solidified stick was clear (homogeneous) resembling a frozen mass. The solid stick solid stick primer solution could be extruded using the cartridge's inbuilt mechanical devices. The primer sticks were tested for primer functionality with a Loctite anaerobic adhesive Loctite 326 on as received mild steel(ARMS), grit blasted mild steel (GBMS),as received aluminium(ARA) and grit blasted aluminium(GBA)as outlined in example 1. above. The results are presented in the following table:

| | Bond Strengths/ | 3 kg Fixture |
|---|---|---|
| | MPa | Times |
| ARMS/ARMS | 9.7 | 70 Seconds |
| GBMS/GBMS | 12.6 | 55 Seconds |
| ARA | 8.9 | 65 Seconds |
| GBA | 12.3 | 60 Seconds |

### Example 9

1.5 g of dibenzylidene sorbitol was dissolved in refluxing ethanol (70 g) with vigorous stirring and the solution allowed to cool for a short period. Then N-phenyl 2 propyl,2,3-diethyl 1,2 dihydropyridine (30.0 g) and cupric bis dimethyl 1,3-acetone dicarboxylate (0.02 g )was added with stirring and the solution was allowed to cool further. The solution was then cast into empty stick cartridges of the type typically used for adhesives, and allowed to cool to room temperature. During this time the solution solidified. The solidified stick was clear (homogeneous) resembling a frozen mass. The solid stick primer solution could be extruded using the cartridges inbuilt mechanical devices. The primer sticks (were tested for primer functionality with a Loctite anaerobic adhesive Loctite 330 on as received mild steel(ARMS), grit blasted mild steel (GBMS),as received aluminium(ARA) and grit blasted aluminium(GBA). As outlined in earlier examples. The results are presented in the following table:

| | Bond Strengths/ |
|---|---|
| | MPa |
| ARMS/ARMS | 20.1 |
| GBMS/GBMS | 23.3 |
| ARA | 18.38 |
| GBA | 20.8 |

Stability

Primer sticks made according to the foregoing Examples were found to be stable retaining their cast shape and remaining active over a number of months and indeed up to a year later. It is believed that the stability of the sticks could last for periods well in excess of one year.

1. A composition comprising:
(a) at least one carrier solvent;
(b) at least one primer component; and
(c) at least one gelling or solidifying agent.

2. A composition according to claim 1 wherein the composition is in the form of a soft-solid, for example in the form of a stick.

3. A composition according to claim 1 or claim 2 wherein the component (c) is the product of at least one aldehyde and/or ketone with a polyol.

4. A composition according to claim 3 wherein the aldehyde is benzaldehyde, 3-chlorobenzaldehyde or 3-fluorobenzaldehyde especially benzaldehyde.

5. A composition according to claim 3 wherein the polyol is sorbitol, xylitol or mannitol especially sorbitol.

6. A composition according to any preceding claim wherein component (c) is an acetal of sugar.

7. A composition according to any preceding claim wherein component (c) is an acetal of sorbitol.

8. A composition according to any preceding claim wherein component (c) is a dibenzylidene sorbitol.

9. A composition according to any preceding claim wherein the component (c) has a concentration in the range of from about 0.01% to about 20% by weight based on the total weight of the composition.

10. A composition according to claim 9 wherein the component (c) has a concentration in the range of from about 0.1 to about 5% by weight based on the total weight of the composition.

11. A composition according to any preceding claim wherein the primer component is present in a concentration of about 0.001 to about 30% by weight based on the total weight of the composition.

12. A composition according to claim 11 wherein the primer component is present in a concentration of about 0.01 to about 2% by weight based on the total weight of the composition.

13. A composition according to any preceding claim wherein the component (a) comprises an organic solvent in which the primer component compound is stable.

14. A composition according to claim 13 wherein said organic solvent is selected from ethanol, methanol, acetone, methyl ethyl ketone, 1,1,1,-trichloroethane, 1,1,2-trichloro-1,2,2,-trifluoroethane or mixtures thereof with each other or with other solvents such as an azeotropic mixture of 1,1,2-trichloro-1,2,2,-trifluoroethane with acetone.

15. A composition according to any preceding claim wherein the primer component is an adhesion-promoting primer component.

16 A composition according to any preceding claim wherein the primer component is selected from:
(i) 1,5-diazabicyclo[4.3.0]non-5-ene having the formula: 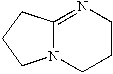
1,8-diazabicyclo[5.4.0]undec-7-ene having the formula: 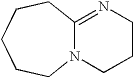
or 1,5,7-triazabicyclo[4.4.0]dec-5-ene having the formula: 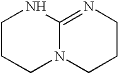
(ii) triphenyl phosphine, or
(iii) ethylenediamine or derivatives of ethylenediamine having the formula: 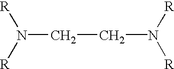
wherein each R, which may be the same or different, represents hydrogen, an alkyl, alkenyl or alkoxy group having 1 to 8 carbon atoms, an aryl group having 6 to 8 carbon atoms, a nitrogen-, sulphur-, or silicon-substituted group having up to 8 carbon atoms or a heterocyclic group having up to 8 carbon atoms which may be unsubstituted or substituted with hydroxy, ether oxygen or sulphur; or
(iv) an imidazole having the formula: 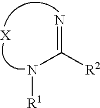
wherein R¹ may be hydrogen; an alkyl group that is unsubstituted or substituted with an OH group or with an (alkyl-O)₃Si group, wherein the alkyl radical has 1 to 4 carbon atoms; an aryl-alkyl group with 7 to 10 carbon atoms; or an imidazole-CO group, and R² may be hydrogen or an alkyl, aryl, or aryl-alkyl group with up to 17 carbon atoms, with the condition that one of the substituents R¹ or R² has an aromatic character and X is one of the groups —CH═CH— or —CR³R⁴—CR⁵R⁶— wherein R³, R⁴, R⁵ and R⁶ independently of one another represent hydrogen, an alkyl group with 1 to 4 carbon atoms, or an aryl-alkyl group with up to 17 carbon atoms.

17. A composition according to any preceding claim wherein the primer component is selected from:
1,5-diazabicyclo[4.3.0]non-5-ene having the formula: 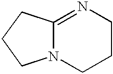
1,8-diazabicyclo[5.4.0]undec-7-ene having the formula: 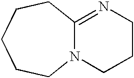
1,5,7-triazabicyclo[4.4.0]dec-5-ene having the formula:

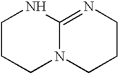

18. A composition according to claim 17 wherein the adhesion promoting agent is
1,8-diazabicyclo[5.4.0]undec-7-ene having the formula:

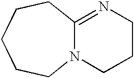

19. A composition according to any one of claims 1 to 16 wherein the primer component is a compound of the Formula: 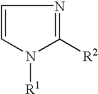
wherein R¹ is a C₁-C₄ alkyl group optionally substituted with a phenyl group, and R² is hydrogen or a C₁-C₄ alkyl group.

20. A composition according to any one of claims 1 to 14 wherein the primer component is a cure-promoting agent.

21. A composition according to claim 20 wherein the primer component is selected from substituted thioureas, a compound having a sulphur-containing free radical source, a compound containing an oxidisable transition metal or a compound containing one of the groups

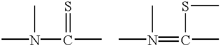

22. A composition according to claim 21 wherein the primer component is a compound containing an oxidisable transition metal.

23. A composition according to claim 22 wherein the transition metal is selected from Cu, Cr, Co, Fe, and Mn.

24. A composition according to claim 23 wherein the transition metal is selected from Cu(I), Cu(II), Co(II), Mn(II), Mn(III) or Cr(II).

25. A composition according to claim 24 wherein the transition metal is selected from Cu(I) or Cu(II).

26. A composition according to claim 25 wherein the transition metal are Cu(I) or Cu(II) salts for example salts of carboxylic acids, beta diketones or beta keto esters.

27. A composition according to claim 26 wherein the salt is Cu(II) 2-ethylhexanoate or Cu(II) acetylacetone.

28. A composition according to any one of claims 21 to 27 wherein the solvent is a polymerizable monomer or polymerizable oligomer.

29. A composition according to claim 28 wherein the solvent is methyl or ethyl methacrylate.

30. A two-part adhesive system comprising (i) at least one cyanoacrylate adhesive and (ii) a composition according to any one of claims 1 to 19.

31. A two-part adhesive system comprising (i) at least one anaerobic product and (ii) a composition according to any one of claims 20 to 29.

32. A method of preparing a shaped mass from the composition of claims 1 to 19 comprising the step of:
(i) heating a composition according to any one of claims 1 to 19 to a desired temperature; and
(ii) allowing the composition to cool or cooling the composition sufficiently to set the composition.

33. A method of preparing a shaped mass from the composition of claims 20 to 29 comprising the step of:
(i) heating a composition according to any one of claims 20 to 29 to a desired temperature; and
(ii) allowing the composition to cool or cooling the composition sufficiently to set the composition.

34. A shaped mass prepared by the method of claim 32.

35. A shaped mass prepared by the method of claim 33.

36. A shaped mass according to claim 34 in stick form.

37. A shaped mass according to claim 35 in stick form.

38. A method of bonding a first substrate to a second substrate comprising the steps of priming at least one of the substrates by application of a composition according to any of claims 1 to 19, applying adhesive to the primed surface and bringing the substrates together to form a bond assembly.

39. A method of bonding a first substrate to a second substrate comprising the steps of priming at least one of the substrates by application of a composition according to any of claims 20 to 29, applying adhesive to the primed surface and bringing the substrates together to form a bond assembly.

40. A method according to claim 38 wherein the at least one substrate to which the composition is applied is constructed of polyolefin.

41. A method according to claim 40 wherein the adhesive is anaerobic and oxygen/air is excluded to allow polymerization to take place.

42. A method according to claim 38 wherein the adhesive is a cyanoacrylate.

43. A bond assembly prepared by bonding a first substrate to a second substrate by the method of any one of claims 38 to 42.

44. A method of sealing a space between two substrates comprising applying to at least one of the substrates a composition according to any one of claims 20 to 29, and bringing the substrates together in the absence of oxygen/air.

45. Use of a primer component, together with a solvent for the primer component, in the manufacture of a stick composition for priming substrates for subsequent bonding.

46. Use of component (c) a gelling or solidifying agent, together with a solvent for the gel or solidifying agent in the manufacture of a primer composition for priming substrates.

47. Use of a composition according to any one of claims 1 to 19 to prime a non-polar or highly crystalline substrate.

48. Use of a composition according to any one of claims 20 to 29 to prime a substrate for bonding with an anaerobic product.

49. A pack comprising (i) a shaped mass of a composition according to any one of claims 1 to 19; and (ii) a container for the composition, the container having a mechanism for expelling the shaped mass.

50. A pack comprising (i) a shaped mass of a composition according to any one of claims 20 to 29 and (ii) a container for the composition, the container having a mechanism for expelling the shaped mass.
